(19) United States
(12) Patent Application Publication
(10) Pub. No.: US 2016/0227152 A1
(43) Pub. Date: Aug. 4, 2016

(54) Remote Controller, Display Device and Remote Control Display System

(71) Applicants: BOE TECHNOLOGY GROUP CO., LTD., Beijing (CN); BEIJING BOE MULTIMEDIA TECHNOLOGY CO., LTD., Beijing (CN)

(72) Inventors: Pei LI, Beijing (CN); Chunguang LV, Beijing (CN); Jing HU, Beijing (CN)

(73) Assignees: BOE Technology Group Co., Ltd, Beijing (CN); Beijing BOE Multimedia Technology Co., Ltd., Beijing (CN)

(21) Appl. No.: 15/022,346

(22) PCT Filed: May 22, 2014
(86) PCT No.: PCT/CN2014/078071

§ 371 Date: Mar. 16, 2016

(30) Foreign Application Priority Data
Dec. 19, 2013 (CN) 201310705719.0

(51) Int. Cl. H04N 5/44

(52) U.S. Cl. CPC H04N 5/4403

(57) ABSTRACT

The present invention provides a remote controller, a display device and a remote control display system. The remote controller comprises a control module and a transmitter module electrically connected to each other, wherein the remote controller is provided with at least five direction keys each corresponding to a different control direction, and when any one of the direction keys is pressed, the control module can control the transmitter module to transmit a direction remote control signal corresponding to the pressed direction key to a remotely controlled display device. The present invention can enable a corresponding object on the remotely controlled display device to move in more directions, thereby significantly simplifying operation steps required for carrying out moving or positioning operation through the remote controller.

### FIELD OF THE INVENTION

The present invention relates to the field of remote control technology, and particularly relates to a remote controller, a display device and a remote control display system.

### BACKGROUND OF THE INVENTION

With the promotion of smart TVs, the demand for interaction between human and TVs has become more obvious. A traditional TV remote controller is shown in FIG. 1, and generally, a direction key 1 thereon only controls a corresponding object (such as mouse cursor) on the TV to move in four directions, namely, up, down, right and left directions. The inventor has found that there are at least the following problems in the prior art: when there is a need to move or position the corresponding object on a smart TV, many operation steps are generally required, which is troublesome, and it is difficult to meet the requirement of smart TV platform.

### SUMMARY OF THE INVENTION

In view of the above problems, the objective of the present invention is to provide a remote controller, a display device and a remote control display system, in order to more conveniently control a corresponding object on the display device to move in a plurality of directions through the remote controller.

In order to achieve the aforementioned objective, the present invention provides a remote controller, including a control module and a transmitter module which are electrically connected, wherein the remote controller is provided with at least five direction keys each corresponding to a different control direction, and when any one of the direction keys is pressed, the control module is able to control the transmitter module to transmit a direction remote control signal corresponding to the pressed direction key.

Preferably, the remote controller is provided with eight direction keys.

Preferably, control directions corresponding to the eight direction keys are upper left, up, upper right, right, lower right, down, lower left, and left, respectively.

Preferably, the eight direction keys are arranged to form a ring.

Preferably, a corresponding circuit module is provided for each direction key, and when any one of the direction keys is pressed, the circuit module corresponding to the pressed direction key is able to be connected to the control module.

Preferably, the direction key includes a press portion and a conductive portion, the circuit module is provided thereon with a switch circuit structure in an off state, and when the press portion of any one of the direction keys is pressed, the conductive portion of the direction key is able to switch on the switch circuit structure of the circuit module corresponding to the direction key, so as to connect the circuit module to the control module.

Preferably, the conductive portion is made of a conductive rubber.

Preferably, the press portions of two or more direction keys are connected to form an integral structure.

Correspondingly, the present invention further provides a display device, including a signal receiving module and a processing module which are electrically connected, wherein the signal receiving module is configured to receive the direction remote control signal transmitted by the remote controller, and the processing module is configured to control a remotely controlled object on the display device to move toward a corresponding direction according to the direction remote control signal.

Correspondingly, the present invention further provides a remote control display system, including the above remote controller provided by the present invention and the display device provided by the present invention, and the display device is able to receive the direction remote control signal transmitted by the remote controller.

The remote controller, the display device and the remote control display system provided by the present invention are described as above. It can be seen that more direction keys each corresponding to a different control direction are arranged on the remote controller provided by the present invention, when a different direction key is pressed, the control module can control the transmitter module to transmit a direction remote control signal corresponding to the pressed direction key, so as to enable the corresponding object on the remotely controlled display device to move in more directions, thereby significantly simplifying operation steps required for carrying out moving or positioning operation through the remote controller. The display device provided by the present invention, including the signal receiving module and the processing module, receives the direction remote control signal from the remote controller through the signal receiving module, and processes the received direction remote control signal through the processing module, so that the remotely controlled object on the display device is controlled to move toward a corresponding direction, thereby realizing convenient remote control operation of the display device. The remote control display system provided by the present invention, including the remote controller and the display device, achieves convenient remote control operation experience through interaction between the remote controller and the display device.

### BRIEF DESCRIPTION OF THE DRAWINGS

The accompanying drawings, which constitute a part of the specification, are used for providing further understanding of the present invention, and explaining the present invention together with following specific implementations but not for limiting the present invention. In the accompanying drawings:

FIG. 1 is a schematic structure diagram of an existing remote controller;

FIG. 2 is a schematic structure diagram of a remote controller provided by the present invention;

FIG. 3 is a schematic structure diagram of a direction key and a switch circuit of a remote controller provided by the present invention;

FIG. 4 is a schematic structure diagram of another remote controller provided by the present invention; and

FIG. 5 is a schematic diagram of a back side of direction keys of a remote controller provided by the present invention.

### DESCRIPTION OF REFERENCE NUMERALS

1, 10: direction key; 11: press portion; 12; conductive portion; 20: switch circuit structure; and 30: elastic support

### DESCRIPTION OF THE PREFERRED EMBODIMENT

Specific implementations of the present invention will be described in detail below with reference to the accompanying drawings. It should be understood that the specific implementations described here are only used for illustrating and explaining the present invention rather than limiting the present invention.

As one aspect of the present invention, a remote controller is provided, as shown in FIGS. 2 to 5, the remote controller includes a control module and a transmitter module electrically connected to each other, the remote controller is provided with at least five direction keys 10, each of which corresponds to a different control direction, and when any one of the direction keys 10 is pressed, the control module can control the transmitter module to transmit a direction remote control signal corresponding to the pressed direction key 10 to a remotely controlled display device.

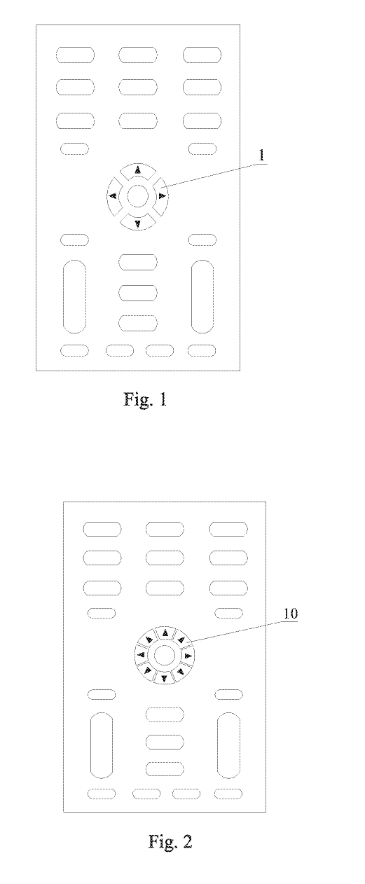

A traditional remote controller is provided with only four direction keys, which respectively correspond to four control directions, namely, up, down, left and right directions (as shown in FIG. 1). However, the remote controller provided by the present invention is provided with at least five direction keys 10 to correspond to at least five control directions, so that the user can more conveniently operate a corresponding object (for example, mouse cursor, menu, etc.) on the remotely controlled display device to move.

Preferably, as shown in FIG. 2, the remote controller may be provided with eight direction keys 10, that is, the eight direction keys 10 may be arranged on the remote controller to correspond to eight different control directions, so that the user can operate the corresponding object on the remotely controlled display device to move in eight different directions. Compared with the prior art, the convenience of the operation is obviously improved.

More preferably, as shown in. FIG. 2, the control directions corresponding to the eight direction keys 10 are upper left, up, upper right, right, lower right, down, lower left, and left, respectively. By employing the aforementioned structure, the user can operate the corresponding object on the remotely controlled display device to move in eight directions, namely, upper left, up, upper right, right, lower right, down, lower left, and left directions. Compared with the prior art, movable direction is partitioned more finely, thereby simplifying the operation steps needed to move or position the corresponding object through the remote controller.

Preferably, as shown in FIG. 2, the eight direction keys 10 may be arranged to form a ring. Specifically, the eight direction keys 10 may be arranged to form a ring on the remote controller according to the respective corresponding control directions. For example, the direction key 10 with upper left control direction may be arranged in an upper left position of the ring, which facilitates intuitive operation of the user, and meanwhile facilitates switching among the keys.

Preferably, for each direction key 10, a corresponding circuit module may be arranged therebelow (in an inward direction perpendicular to the principal plane), and when any one of the direction keys 10 is pressed, the circuit module corresponding to the pressed direction key 10 can be connected to the control module. Specifically, below each direction key 10, a circuit module corresponding thereto may be arranged. For example, a circuit module corresponding to an upper left control direction may be arranged below the direction key 10 with the upper left control direction, and the circuit modules may be differentiated by different preset voltage values or current values. Therefore, when any one of the direction keys 10 is pressed, the circuit module arranged below said direction key is connected to the control module, so that the control module can acquire the control direction corresponding to the pressed direction key 10 according to the current voltage value or current value and the preset different voltage values or current values, for example, thereby controlling the transmitter module to transmit a corresponding direction remote control signal.

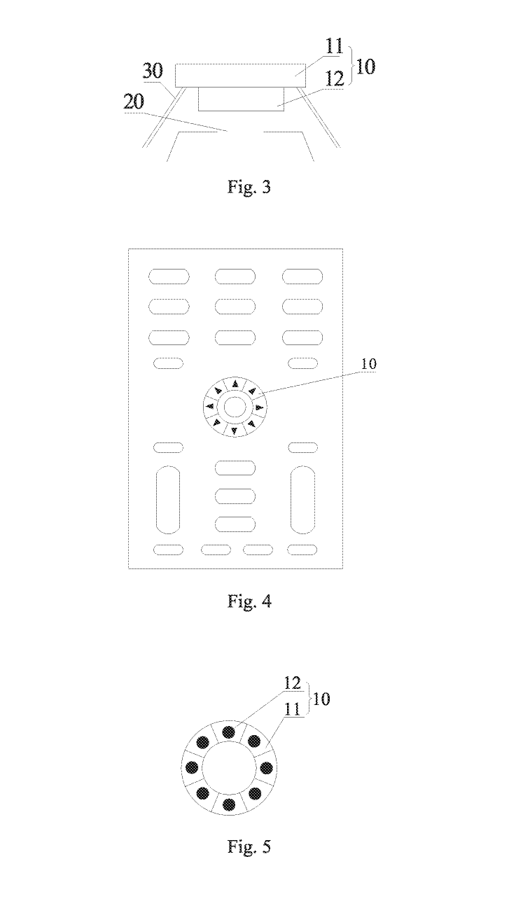

More preferably, as shown in FIG. 3, the direction key may include a press portion 11 and a conductive portion 12 located at a lower end of the press portion, the circuit module may be provided thereon with a switch circuit structure 20 in an off state, and when the press portion 11 of any one of the direction keys 10 is pressed, the conductive portion 12 of the direction key 10 can switch on the switch circuit structure 20 of the circuit module corresponding to the direction key 10, so as to connect the circuit module to the control module. Specifically, as shown in FIG. 3, an elastic support 30 for supporting the direction key 10 may be arranged below the direction key 10, so that the direction key 10 is in an up state when not being pressed. With the aforementioned structure, when the direction key 10 is not pressed, the switch circuit structure 20 remains in the off state, when the direction key 10 is pressed, the switch circuit structure 20 can be switched on through the conductive portion 12 so as to connect the circuit module corresponding to the pressed direction to the control module, so that the control module can acquire the control direction corresponding to the pressed direction key 10. The elastic support 30 may be made of a member capable of providing elasticity, such as spring, elastic sheet, etc., which is not repeatedly described herein.

Preferably, the conductive portion 12 may be made of a conductive rubber. By employing the conductive rubber, not only the switch circuit structure 20 can be switched on, but also the down force during pressing the direction key 10 can be buffered, thereby allowing an operator to operate more comfortably.

More preferably, the press portions 11 of two or more direction keys 10 may be connected to form an integral structure. Specifically, as shown in FIGS. 4 and 5, the press portions 11 of the eight direction keys 10 respectively corresponding to upper left, up, upper right, right, lower right, down, lower left, and left control directions may be connected to form an integral structure, alternatively, the press portions 11 of some direction keys 10 may be connected to form an integral structure as required. The press portions 11 of the eight direction keys 10 are integrally formed to facilitate switching among the direction keys 10 by the user, and at the same time, only one corresponding ring-shaped hole needs to be provided in a panel of the remote controller, which facilitates processing and manufacturing. In addition, since the press portions 11 are of an integral structure, an integral molding process may be employed, which facilitates both processing and assembling. Specifically, as shown in FIG. 5, when the press portions 11 of the eight direction keys 10 are integrally formed, the conductive portions 12 of the direction keys 10 may be independent mutually, in order to switch on the switch circuit structure of the corresponding circuit module.

The remote controller provided by the present invention is described as above. It can be seen that, in the present invention, by arranging more direction keys each corresponding to a different control direction on the remote controller, when a different direction keys is pressed, the control module can control the transmitter module to transmit a direction remote control signal corresponding to the pressed direction key, so as to enable the corresponding object on the remotely controlled display device to move in more directions, and significantly simplify operation steps required for carrying out moving or positioning operation through the remote controller. Compared with the prior art, it is more suitable for the application requirements of a smart TV platform.

As another aspect of the present invention, a display device is provided, the display device includes a signal receiving module and a processing module, which may be electrically connected to each other; the signal receiving module may be used to receive the direction remote control signal transmitted by the remote controller provided by the present invention, and the processing module may be used to control the remotely controlled object on the display device to move toward a corresponding direction according to the direction remote control signal.

The display device provided by the present invention, including the signal receiving module and the processing module, receives the direction remote control signal from the remote controller through the signal receiving module, and processes the received direction remote control signal through the processing module, so that the remotely controlled object on the display device is controlled to move toward a corresponding direction, thereby achieving convenient remote control operation of the display device.

As still another aspect of the present invention, a remote control display system is provided, the remote control display system includes the remote controller provided by the present invention and the display device provided by the present invention, wherein, the display device provided by the present invention can receive the direction remote control signal transmitted by the remote controller provided by the present invention, and control the corresponding object to move toward the corresponding direction.

The remote control display system provided by the present invention, including the remote controller and the display device, may achieve convenient remote control operation experience through interaction between the remote controller and the display device.

It may be understood that, the foregoing implementation are exemplary implementations merely used for describing the principle of the present invention, and the present invention is not limited thereto. For a person of ordinary skill in the art, various variations and improvements may be made without departing from the spirit and essence of the present invention, and those variations and improvements are also regarded as falling into the protection scope of the present invention.

1-10. (canceled)

11. A remote controller, comprising a control module and a transmitter module electrically connected to each other, wherein the remote controller is provided with at least five direction keys each corresponding to a different control direction, and when any one of the direction keys is pressed, the control module controls the transmitter module to transmit a direction remote control signal corresponding to the pressed direction key.

12. The remote controller according to claim 11, wherein the remote controller is provided with eight direction keys.

13. The remote controller according to claim 12, wherein the control directions corresponding to the eight direction keys are upper left, up, upper right, right, lower right, down, lower left, and left, respectively.

14. The remote controller according to claim 12, wherein the eight direction keys are arranged to form a ring.

15. The remote controller according to claim 13, wherein the eight direction keys are arranged to form a ring.

16. The remote controller according to claim 11, wherein a corresponding circuit module is provided for each direction key, and when any one of the direction keys is pressed, the circuit module corresponding to the pressed direction key is connected to the control module.

17. The remote controller according to claim 12, wherein a corresponding circuit module is provided for each direction key, and when any one of the direction keys is pressed, the circuit module corresponding to the pressed direction key is connected to the control module.

18. The remote controller according to claim 13, wherein a corresponding circuit module is provided for each direction key, and when any one of the direction keys is pressed, the circuit module corresponding to the pressed direction key is connected to the control module.

19. The remote controller according to claim 16, wherein the direction key comprises a press portion and a conductive portion, the circuit module is provided thereon with a switch circuit structure in an off state, and when the press portion of any one of the direction keys is pressed, the conductive portion of the direction key switch on the switch circuit structure of the circuit module corresponding to the direction key, so as to connect the circuit module to the control module.

20. The remote controller according to claim 17, wherein the direction key comprises a press portion and a conductive portion, the circuit module is provided thereon with a switch circuit structure in an off state, and when the press portion of any one of the direction keys is pressed, the conductive portion of the direction key switch on the switch circuit structure of the circuit module corresponding to the direction key, so as to connect the circuit module to the control module.

21. The remote controller according to claim 18, wherein the direction key comprises a press portion and a conductive portion, the circuit module is provided thereon with a switch circuit structure in an off state, and when the press portion of any one of the direction keys is pressed, the conductive portion of the direction key switch on the switch circuit structure of the circuit module corresponding to the direction key, so as to connect the circuit module to the control module.

22. The remote controller according to claim 19, wherein the conductive portion is made of a conductive rubber.

23. The remote controller according to claim 20, wherein the conductive portion is made of a conductive rubber.

24. The remote controller according to claim 21, wherein the conductive portion is made of a conductive rubber.

25. The remote controller according to claim 19, wherein the press portions of two or more direction keys are connected to form an integral structure.

26. The remote controller according to claim 20, wherein the press portions of two or more direction keys are connected to form an integral structure.

27. The remote controller according to claim 21, wherein the press portions of two or more direction keys are connected to form an integral structure.

28. The remote controller according to claim 22, wherein the press portions of two or more direction keys are connected to form an integral structure.

29. A display device, comprising a signal receiving module and a processing module electrically connected to each other; wherein the signal receiving module is configured to receive the direction remote control signal transmitted by the remote controller according to claim 11, and the processing module is configured to control a remotely controlled object on the display device to move toward a corresponding direction according to the direction remote control signal.

30. A remote control display system, comprising the remote controller according to claim 11 and the display device according to claim 9, wherein the display device receives the direction remote control signal transmitted by the remote controller.
